(19) United States
(12) Patent Application Publication
(10) Pub. No.: US 2005/0000642 A1
(43) Pub. Date: Jan. 6, 2005

(54) Cling articles

(75) Inventors: Albert I. Everaerts, Oakdale, MN (US); Lang N. Nguyen, St. Paul, MN (US); Vivek Bharti, Cottage Grove, MN (US); Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/613,249

(22) Filed: Jul. 3, 2003

(51) Int. Cl. B32B 7/12; B32B 31/00

(52) U.S. Cl. 156/273.1; 156/275.5; 428/347; 428/348

(57) ABSTRACT

Cling articles comprise a cling backing a first heat-activatable adhesive in contact with at least a portion of a major surface of the cling backing. The heat-activatable adhesive has an activation temperature of at least about 40 degrees Celsius, and has a gel content at or above the activation temperature of at least about 5 percent.

### BACKGROUND

The term “cling film” is commonly used to refer to a film that can cling to a substrate without the use of adhesives or fasteners. Cling films are generally divided into two major types: cling vinyl films and electrostatic cling films.

Cling vinyl films (also known as “static cling vinyl” films) are vinyl films that typically contain plasticizers and/or tackifiers. Cling vinyl films typically adhere to substrates primarily by capillary forces rather than electrostatic forces. As a result, cling vinyl films can typically be adhered to smooth, rigid surfaces such as glass windows, but typically do not adhere well to porous, rough and/or dusty surfaces.

Electrostatic cling films are films that have an electrostatic charge. Such films generally exhibit electrostatic attraction to a wide variety of substrates thereby allowing the films to be removably adhered to surfaces, including those not readily adhered to by cling vinyl films as discussed above. To reduce electrostatic charge dissipation, electrostatic cling films often comprise an electret charge (i.e., a permanent or semi-permanent electrostatic charge).

Typically, the ability of cling films to adhere to a substrate diminishes over time due, for example, to environmental factors such as humidity, and age of the cling film. This loss of adhesion is typically undesirable for those applications in which adhesion for months or years is desired, and/or wherein exposure to the elements (e.g., water, wind, etc.) is likely as, for example, in outdoor applications.

To increase adhesion, various activatable adhesives have been used in combination with electrostatically charged films. The resultant adhesive coated films are positionable, and if desired the activatable adhesive can be activated to provide increased adhesion to a substrate. Known activatable adhesives for use with electrostatically charged films include repositionable pressure-sensitive adhesives, positionable pressure-sensitive adhesives, pressure-sensitive adhesives provided with a removable release liner, hot melt adhesives, and microencapsulated adhesives.

During use, electrostatically charged films coated with a pressure-sensitive adhesive such as those described above can become prematurely adhered to themselves or to a substrate, for example, by excessive handling, bumping, or other manipulation, especially if large and unwieldy.

Electrostatically charged films coated with microencapsulated adhesives are typically non-tacky to the touch, but they require pressure and shear to break the microcapsules and expose the adhesive inside. The pressure required to rupture the microcapsules is typically quite high, making this type of adhesive typically unsuitable for use with non-rigid substrates.

In contrast, hot melt adhesive coated electrostatically charged films are deliberately activated by application of heat, and are not typically prone to such accidental adhesion problems of pressure-sensitive adhesives. However, since hot melt adhesives melt, they are susceptible to flowing into porous substrates, thereby causing problems in subsequent removal of the film including, for example, leaving residue on the substrate and/or causing damage to the substrate. In addition, since hot melt adhesives require a low melt viscosity for bond making, significant heat has to be applied to melt the material, often requiring specialized equipment, such as extruders, grid melters, or heat laminators. Indeed, common hot-melts are often applied at temperatures in excess of 120 degrees Celsius, with 150-190 degrees Celsius being typical. These melt temperatures are very difficult to achieve with common house hold devices like a hair dryer, and caution has to be exercised to prevent heat damage to the substrate and/or any plastic films. Finally, since hot melt adhesives are applied and used in their fluid state, no crosslinking can be tolerated, making application of a hot melt coated article more challenging since any accidental touch of the substrate could result in adhesive transfer or the article sliding until the adhesive cools and hardens sufficiently to prevent creep. If for any reason, the applied article would reach the heat activation temperature for the hot-melt during shipment or use of the coated article, cohesive failure of the adhesive may also result and/or the product could show lifting and creep.

It would be desirable to have cling films that, once activated, can be strongly adhered to a surface of a substrate. It would also be desirable that activated cling films not leave adhesive residue if brought into casual or accidental contact with a substrate.

### SUMMARY

In one aspect, the present invention provides a cling article comprising:
a cling backing having first and second opposed major surfaces; and
a heat-activatable adhesive in contact with at least a portion of the first major surface, wherein the heat-activatable adhesive has an activation temperature of at least about 40 degrees Celsius, and wherein the heat-activatable adhesive has a gel content at or above the activation temperature of at least about 5 percent.

In one aspect, the present invention provides a method of adhering a cling article to a substrate comprising:
providing a cling backing having first and second opposed major surfaces and a first heat-activatable adhesive in contact with at least a portion of the first major surface, wherein the heat-activatable adhesive has a first activation temperature of at least about 40 degrees Celsius, and wherein the heat-activatable adhesive has a gel content at or above the activation temperature of at least about 5 percent;
contacting the cling backing with a substrate; and
heating the heat-activatable adhesive to a temperature at which the heat-activatable adhesive becomes aggressively tacky.

In one aspect, the present invention provides a cling article comprising:
a cling backing having first and second opposed major surfaces;
a first heat-activatable adhesive in contact with at least a portion of the first major surface, wherein the heat-activatable adhesive has a first activation temperature of at least about 40 degrees Celsius, and wherein the heat-activatable adhesive has a gel content at or above the activation temperature of at least about 5 percent; and
a substrate in contact with the heat-activatable crosslinked adhesive.

Articles according to the present invention removably cling to substrates, and can be activated at low temperature to provide an adhesive bond. Typically, bonded articles according to the present invention can be easily and substantially completely removed from a variety of substrates.

As used herein:
“activation temperature” refers to the minimum temperature below which a material is essentially non-tacky, yet becomes aggressively tacky if increased by from two to ten degrees Celsius;
“pressure-sensitive adhesive” refers to an adhesive that at room temperature has permanent tack, is aggressively tacky, can be adhered without the need of more than finger or hand pressure, requires no activation by water, solvent, or heat, exerts a strong holding force, and has sufficient cohesiveness and elasticity that it can be removed from smooth surfaces without leaving residue;
“aggressively tacky” means that the adhesive when applied to a piece of copy paper (commercially available under the trade designation “HAMMERMILL COPY PLUS, 20 LB WEIGHT” from International Paper, Memphis, Tenn. or its equivalent) using one pass (back and forth) of a 4.5 pound (2.0 kg) rubber roller will adhere securely to the paper and tear it when peeled by hand;
“film” refers to a continuous nonporous thin layer of material having two opposed major surfaces, and includes for example, rolls, sheets, tapes, and strips;
“non-tacky” means that the adhesive when applied to a piece of copy paper (commercially available under the trade designation “HAMMERMILL COPY PLUS, 20 LB WEIGHT” from International Paper, Memphis, Tenn. or its equivalent) using one pass (back and forth) of a 4.5 pound (2.0 kg) rubber roller will not adhere securely to the paper, allowing it to be peeled from the adhesive without significant damage to the paper; and
“(meth)acryl” includes both acryl and methacryl.

### BRIEF DESCRIPTION OF THE DRAWING

FIG. 1 is a schematic cross-section of an exemplary cling article according to the present invention; and

FIG. 2 is a schematic cross-section of an exemplary assembly according to the present invention.

### DETAILED DESCRIPTION

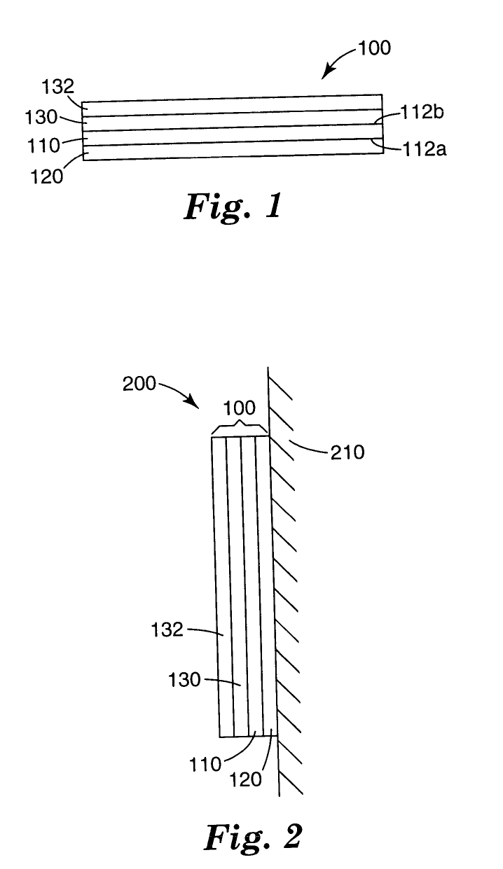

As shown in FIG. 1, exemplary cling article 100 according to the present invention comprises cling backing 110 having first and second opposed major surfaces 112a and 112b, respectively. A layer of heat-activatable adhesive 120 contacts first major surface 112a. Optional layers that may be disposed on second major surface 112b include image-receiving layer 130 and dry erase layer 132.

In use, cling articles of the present invention are typically bonded to substrates to form assemblies. As shown in FIG. 2, an assembly 200 comprises cling article 100 (i.e., having cling backing 110, heat-activatable adhesive 120, optional image-receiving layer 130, and optional dry erase layer 132 as described in FIG. 1) in contact with substrate 210. Initially, cling article 100 adheres to substrate 210 according to the specific properties of cling backing 110. Cling article 100 is then typically slid, smoothed, or otherwise manipulated until it is positioned as desired, and then heat and at least slight pressure are applied so as to cause heat-activatable adhesive 120 to adhesively bond to substrate 210.

As used herein, the term “cling backing” refers to a backing that can cling to a substrate without the use of adhesives or fasteners. Useful cling backings may be porous, nonporous, and/or optionally surface treated (e.g., primed, AC corona treated). Cling backings that may be used in practice of the present invention include, for example, cling vinyl backings and electrostatically charged backings (e.g., electrostatically charged films, microporous films, woven backings, nonwoven backings (e.g., blown microfiber backings, and spunbond backings)). The cling backing may be a unitary film (i.e., a single layer) or it may be multi-layered. The cling backing may be opaque, transparent, or translucent, and may have distinct regions of differing opacity. The cling backing may be perforated or non-perforated.

Cling vinyl (also known as “static cling vinyl”) technology is well known. Useful cling vinyl backings are typically films. Cling vinyl films generally comprise plasticized and/or tackified polyvinyl chloride, and generally cling to substrates due to physical principles other than electrostatic attraction. Cling vinyl films typically cling to smooth, rigid surfaces such as glass windows, but do not adhere well to porous, rough and/or dusty surfaces. Cling vinyl films are widely known in the art and are available commercially and may be obtained for example from Molco, Waymart, Pa.; Transilwrap Company, Franklin Park, Ill.; and Flexcon, Spencer, Mass. In order to cling, it is generally necessary to have direct contact between a cling vinyl film and a substrate. Thus, if a cling vinyl film is used as the cling backing, the heat-activatable adhesive should not be provided as a continuous coterminous layer on a major surface of the film, but rather as a discontinuous and/or partial layer. To prevent loss of cling properties, cling vinyl films are generally supplied on a liner (e.g. a silicone treated paper) that is designed to be removed immediately prior to application of the cling vinyl film to a substrate.

In contrast to cling vinyl backings, electrostatically charged backings typically adhere to surfaces by electrostatic attraction, and adhere even to rough or dusty surfaces. Electrostatically charged backings may have a temporary, semi-permanent, or permanent electrostatic charge.

Temporary electrostatic charge may be imparted to a backing, for example, by tribocharging. Tribocharging may be accomplished by any known means including, for example, rubbing the backing with, or peeling the backing from a liner of a dissimilar material (e.g., located toward the opposite end of the triboelectric series).

Cling backings having a semi-permanent or permanent electrostatic charge may be achieved by using an electret material as the backing (i.e., an electret backing). Electret backings can be readily obtained from commercial sources or prepared by a variety of methods that are well known in the art. For details on methods for making electret films, see, for example, “Electrets”, G. M. Sessler (ed.), Springer-Verlag, N.Y., 1987. Further details concerning electret materials suitable for use as backings and their preparation may be found, for example, in U.S. patent Publication No. 2002/0090480 (Hsu et al.); and in U.S. Pat. No. 6,123,752 (Wu et al.) and U.S. Pat. No. 6,214,094 (Rousseau et al.), the disclosures of which are incorporated herein by reference.

Exemplary methods of forming electrets are well known in the art and include thermal electret, electroelectret (e.g., direct current (i.e., DC) corona discharge), radioelectret, magnetoelectret, photoelectret, and mechanical electret forming methods as described in, for example, U.S. Pat. No. 5,558,809 (Groh et al.), the disclosure of which is incorporated herein by reference. Typically, electret backings utilized in practice of the present invention have a charge (i.e., electret charge) density of greater than about 0.005 nanocoulombs per square centimeter (nC/cm²), for example, greater than about 0.5 nC/cm², or even greater than about 5 nC/cm². DC corona charging (e.g., as described in, for example, U.S. Pat. No. 6,001,299 (Kawabe et al.) and U.S. Pat. No. 4,623,438 (Felton et al.), the disclosures of which are incorporated herein by reference) is a desirable and convenient method for preparing electret films that are useful in practice of the present invention. Exemplary commercially available electret backings include polypropylene electret films available under the trade designation “CLINGZ” from Permacharge Corporation, Rio Rancho, N.Mex.

Electret backings, useful in practice of the present invention, typically comprise a thermoplastic polymeric material, optionally containing various fillers and additives.

Useful thermoplastic polymeric materials that can maintain an electret charge include, for example, fluorinated polymers (e.g., polytetrafluoroethylene, polyvinylidene fluoride, tetrafluoroethylene-hexafluoropropylene copolymers, vinylidene fluoride-trifluorochloroethylene copolymers), polyolefins (e.g., polyethylene, polypropylene, poly(4-methyl-1-pentene), propylene-ethylene copolymers), copolymers of olefins and other monomers (e.g., ethylene-vinyl acetate copolymers, ethylene-acrylic acid copolymers, ethylene-maleic acid anhydride copolymers, propylene-acrylic acid copolymers, propylene-maleic acid anhydride copolymers, (4-methyl-1-pentene)-acrylic acid copolymers, (4-methyl-1-pentene)-maleic acid anhydride copolymers), ionomers (e.g., ethylene-(meth)acrylic acid copolymers with at least some acidic protons replaced by Na⁺, K⁺, Ca²⁺, Mg²⁺, or Zn²⁺ cations), polyesters (e.g., polyethylene terephthalate), polyamides (e.g., nylon-6, nylon-6,6), polycarbonates, polysulfones, non-plasticized polyvinyl chloride, and combinations thereof.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930”, “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, “SURLYN 8945”; zinc poly(ethylene-co-methacrylic acid) ionomers such as “SURLYN 1705-1”, “SURLYN 1706”, SURLYN 6101” , SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, “SURLYN PC-100”) by E. I. du Pont de Nemours & Company, Wilmington, Del.; or as marketed under the trade designation “IOTEK” (e.g., sodium poly(ethylene-co-acrylic acid) ionomers such as “IOTEK 3110”, “IOTEK 3800”, or “IOTEK 8000”; and zinc poly(ethylene-co-acrylic acid) ionomers such as “IOTEK 4200”) by ExxonMobil Corporation, Houston, Tex. Further details of useful poly(ethylene-co-(meth)acrylic acid) ionomers are described in, for example, commonly assigned U.S. application Ser. No. 10/231,570 entitled “METHOD OF ADHERING A CLING ARTICLE AND ARTICLES THEREFROM” (Bharti et al.), filed Aug. 30, 2002, the disclosure of which is incorporated herein by reference.

If the polymer is obtained in pellet form, the pellets may be melt-extruded, for example, as a film, blown microfiber web, or spunbonded web, using procedures well known in the art. Typically, the thickness of the electret film is in the range of from about 10 to about 2500 micrometers, although thinner and thicker films may also be used. For example, the electret film may have a thickness in the range of from about 25 to about 310 micrometers, or in a range of from about 50 to about 110 micrometers.

Optionally, one or more additives can be included in the thermoplastic polymer. Exemplary optional additives include antioxidants, light stabilizers (e.g., as available from Ciba Specialty Chemicals, Tarrytown, N.Y. under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. No. 5,976,208 (Rousseau et al.) and U.S. Pat. No. 6,397,458 (Jones et al.)), glass beads, glass bubbles, colorants (e.g., dyes, pigments (including phosphorescent pigments), and fragrances.

Exemplary optional additives also include titanium dioxide (e.g., in particulate form). If present, the amount of titanium dioxide typically is in a range of from about 1 to about 50 percent by volume, and/or in a range of from about 1 to about 20 percent by volume, based on the total volume of the film, although greater and lesser amounts of titanium dioxide particles may also be used.

The heat-activatable adhesive may be any material having an activation temperature, as defined hereinabove, of at least 40 degrees Celsius. Useful heat-activatable adhesives include, for example, those containing crosslinked semi-crystalline polymers, over-tackified adhesives, delayed tack adhesives containing solid plasticizers, such as those described in U.S. Pat. No. 6,080,480 (Shiba et al.), surface detackified pressure-sensitive adhesives such as those described in WO 96/08540 (Rice et al), two component adhesives such as those described in U.S. Pat. No. 4,135,033 (Lawton), and combinations of wax and an elastomer.

Useful heat-activatable adhesives typically have at most moderate tack, typically little or no tack, at room temperature, thus allowing for easy positioning and repositioning (i.e., the adhesive does not adhere securely with simple application of finger or hand pressure). However, upon heating to a temperature at or above their activation temperature they become aggressively tacky. Once activated, the adhesive becomes aggressively tacky, remains cohesively strong (i.e., does not become fluid), and can be applied with simple finger or hand pressure and remains securely bonded to the substrate, even after cooling back to room temperature. Cooling to room temperature causes the aggressive tack to disappear. The whole process is typically repeatable, so successive heating and cooling steps can turn the aggressive tack on and off,

In order to prevent flow, and maintain aggressively tacky adhesive properties at temperatures above the activation temperature, the heat-activatable adhesive typically may have a gel content at or above the activation temperature of from at least about 5, 10, 15, 20, 40, or even at least about 50 percent, up to and including 100 percent. The gel network is typically the result of covalent or ionomeric polymer crosslinks, but may in some cases (e.g., a combination of wax and a styrene-butadiene-styrene block copolymer elastomer) crosslinking may result from physical polymer crosslinks (e.g., high glass transition or crystalline regions).

Gel content can be measured by any known techniques. In the cases of covalently crosslinked polymer networks the gel content can be determined according to the Gel Content Test set forth in the Examples section using a good solvent (optionally instead of toluene) for the uncrosslinked polymer and using an appropriate temperature. In the case of physically crosslinked polymer networks the gel content can be determined generally according to the Gel Content Test set forth in the Examples section using a good solvent (optionally instead of toluene) for the elastomeric portion, that is also a non-solvent for the hard segment (e.g., high Tg blocks) and using an appropriate temperature.

One useful heat-activatable adhesives includes organic covalently crosslinked semi-crystalline polymer. Such polymers may have crystalline domains in their backbone and/or pendant side chains. Examples of main chain crystalline polymers include poly(ethylene oxide) urea and urethane elastomers obtained by reacting poly(ethylene oxide) amines or diols with polyfunctional isocyanates. The melting point of the main chain is controlled by the polyethylene oxide segments, and the crosslink density can be controlled, for example, by the choice of polyfunctional isocyanate, or by incorporating moisture curable silane terminal groups into the polymer as is known in the art. Useful crosslinked semi-crystalline organic polymers include, for example, semi-crystalline acrylic polymers formed by polymerization of monomers including at least one n-alkyl (meth)acrylate monomer wherein the n-alkyl group has at least about 20 carbon atoms (referred to herein after as the C₂₀₊ (meth)acrylate monomer), at least one alkyl (meth)acrylate monomer wherein the alkyl group has from about 4 to about 12 carbon atoms (referred to herein after as the C₄-C₁₂ (meth)acrylate monomer), and optionally a polar monomer.

Without wishing to be bound by theory, it is believed that C₂₀₊ (meth)acrylate monomer units at concentrations used in the present invention impart a degree of crystallinity resulting in low tack at room temperature. The crystalline content of polymeric materials can be measured using differential scanning calorimetry, for example, according to the Crystallinity Content Determination test method given in the Examples section hereinbelow. In order to achieve adhesion, low tack at temperatures below the activation temperature, and removability, the degree of crystalline content should preferably be in a range of from at least about 5, 10, or even 15 percent crystalline content by weight up to and including about 20, 25, or even about 30 percent crystalline content by weight. Low crystalline content typically results in increased and permanent tack at room temperature, while higher levels of crystalline content typically result in little or no tack, even after heat activation.

In contrast, it is believed that the C₄-C₁₂ alkyl (meth)acrylate monomer units contribute a degree of tack at room temperature or above. Optional polar monomer units improve the adhesive strength of the adhesive.

C₂₀₊ (meth)acrylate monomer units in the polymer may comprise from at least about 20, 30, 35, 40, or even about 45 percent by weight up to and including about 50, 55, 60, 65, or even about 70 percent by weight of the polymer. However, if the polymer does not include a non-acidic polar monomer, then the minimum amount of C₂₀₊ (meth)acrylate monomer that should be included in the polymer is at least about 40 percent by weight.

Useful C₂₀₊ (meth)acrylate monomers include, for example, eicosanyl (meth)acrylate, behenyl (meth)acrylate, hexacosanyl (meth)acrylate, and combinations thereof. Other useful (meth)acrylate monomers of alcohols having more than 20 carbons can be obtained, for example, by esterifying commercially available alcohols having more than 20 carbon atoms available under the trade designations “UNILIN” and “UNITHOX” (available from Baker Petrolite, Sugar Land, Tex.) with (meth)acryloyl chloride in the presence of a tertiary amine.

C₄₋₁₂ (meth)acrylate monomer units in the polymer may comprise from at least about 30, 35, 40, or even about 45 percent by weight up to and including about 50, 55, 60, 65, 70, or even about 80 percent by weight of the polymer. C₄₋₁₂ (meth)acrylate monomers may be linear or branched monofunctional (meth)acrylate esters of non-tertiary alcohols. These lower linear and branched acrylates may provide the properties of low glass transition temperature and viscoelastic characteristics that result in materials that are tacky in nature. Examples of the shorter chain, lower alkyl acrylates and methacrylates used in the invention include, for example, n-butyl (meth)acrylate, isobutyl (meth)acrylate, 2-ethylhexyl (meth)acrylate, isooctyl (meth)acrylate, n-octyl (meth)acrylate, 2-methylbutyl (meth)acrylate, isononyl (meth)acrylate, isoamyl (meth)acrylate, isodecyl (meth)acrylate, 4-methyl-2-pentyl (meth)acrylate, and combinations thereof.

Polar monomer units may be included in the polymer in an amount of up to 20 percent by weight in the case of N-vinyl lactams, and in an amount up to including 10 percent by weight in the case of other monomers, however amounts of less than or equal to about 5 percent or even less than or equal to 1 percent are useful in many cases.

Useful ethylenically-unsaturated polar monomers that may be copolymerized with the C₄₋₁₂ (meth)acrylate and C₂₀₊ (meth)acrylate monomers discussed hereinabove include include strongly polar and moderately polar monomers.

Strong polar monomers include, for example, mono-, di-, and multi-functional carboxylic acids and salts (e.g., (meth)acrylic acid itaconic acid, crotonic acid, maleic acid, and fumaric acid), cyanoalkyl acrylates, (meth)acrylamides, and acrylonitriles.

Moderately polar monomers include, for example, N-vinyllactams (e.g., N-vinylcaprolactam and N-vinylpyrollidone), vinyl halides (e.g., vinyl chloride and vinylidene chloride), styrenes, hydroxyalkyl (meth)acrylates (e.g., 2-hydroxyethyl acrylate and 3-hydroxypropyl methacrylate).

Crosslinking of the semi-crystalline polymer may be accomplished, for example, by including a crosslinking agent with the C₄₋₁₂ (meth)acrylate and C₂₀₊ (meth)acrylate monomers prior to polymerization to form the semi-crystalline polymer, and/or by including at least one multifunctional monomer (crosslinking monomer) in the monomer mixture prior to polymerization. Useful ethylenically-unsaturated crosslinking agents that may be included in the monomer mixture include, for example, multifunctional (meth)acrylates (e.g., 1,4-butanediol di(meth)acrylate, 1,6-hexanediol di(meth)acrylate, pentaerythritol tri(meth)acrylate and polyfunctional (meth)acrylic monomers described in U.S. Pat. No. 4,379,201 (Heilmann et al.), the disclosure of which is incorporated herein by reference). Other useful ethylenically-unsaturated crosslinking agents that can be included in the monomer mixture, but which may form crosslinks subsequent to forming the semi-crystalline polymer include mono-ethylenically-unsaturated aromatic ketones (e.g., 4-acryloyl-oxy-benzophenone, as described in U.S. Pat. No. 4,737,559 (Kellen et al.)), high glass transition temperature macromers, and ethylenically-unsaturated silanes (e.g., monoethylenically-unsaturated mono-, di-, or tri-alkoxysilanes).

Semi-crystalline polymers may be prepared, for example, using suspension, emulsion, or solution polymerization methods using procedures well known in the art.

Alternatively, or in addition, the semi-crystalline polymer may be crosslinked after polymerization. Crosslinking agents that may be used in this regard are well known in the art and typically selected based on the chemical functionality of the semi-crystalline polymer. For example, if the semi-crystalline polymer includes acid groups useful crosslinking agents include, for example, multifunctional aziridineamides (e.g., 1,1′-(1,3-phenylenedicarbonyl)bis[2-methylaziridine]; 2,2,4-trimethyladipoylbis[2-ethylaziridine], 1,1′-azelaoylbis[2-methylaziridine]) and aziridinyl triazines (e.g., 2,4,6-tris(2-ethyl-1-aziridinyl)-1,3,5-triazine); metal ion crosslinking agents (e.g., copper, zinc, zirconium, and chromium ions), and combinations thereof. Examples of metal ion crosslinking agents include chelated esters of orthotitanic acid marketed under the trade designation “TYZOR” by E.I. du Pont de Nemours & Company, Wilmington, Del. (e.g., titanium acetyl acetonate marketed under the trade designation “TYZOR AA”).

If hydroxy functional moderately polar monomers such as 2-hydroxyethyl acrylate or 3-hydroxypropyl methacrylate are utilized, polyfunctional isocyanate crosslinking agents may be effectively utilized. Useful polyfunctional crosslinking agents include aromatic polyfunctional isocyanates (e.g., toluene diisocyanate), aralkylene polyfunctional isocyanates (e.g., bis (4-isocyanatophenyl)methane), cycloaliphatic polyfunctional isocyanates (e.g., bis(4-isocyanatohexyl)methane), and aliphatic polyfunctional isocyanates (e.g., hexamethylene diisocyanate and tetramethylene diisocyanate).

Crosslinking by exposure to ultraviolet radiation following the initial polymerization may also be used, for example, using crosslinking agents such as chromophore-substituted halomethyl-s-triazines described in U.S. Pat. No. 4,329,384 (Vesley et al.); U.S. Pat. No. 4,330,590 (Vesley); and U.S. Pat. No. 4,379,201 (Vesley), the disclosures of which are incorporated herein by reference.

Typically, the amount of crosslinking agent varies from about 0.01 weight percent to about 10 percent by weight based on the total weight of the composition, however the amount of the crosslinking agent used depends upon the type of crosslinking agent used, and other amounts of crosslinking agent can be used. The amount of crosslinking agent utilized should result in aggressive tack when the heat-activatable adhesive is activated, but does not result in visible adhesive residue on a substrate when articles according to the present invention are later removed from a substrate surface.

Over-tackified adhesives may also be used as heat-activatable adhesives. These adhesives typically include an elastomer and a large amount of tackifying resin, the latter being included in a sufficient amount to increase the glass transition temperature (Tg) of the resultant adhesives to a level needed for convenient and effective room-temperature handling of sheets coated with the adhesive. On heating, the tackifier softens or melts and aggressive tack develops. On subsequent cooling, the tackifier resolidifies resulting in a loss of aggressive tack. Examples of over-tackified adhesives are described in U.S. Pat. No. 4,248,748 (McGrath et al.), the disclosure of which is incorporated herein by reference. Useful tackifying resins are generally well-known resins; typically thermoplastic resinous room-temperature solids characterized by their ability to increase the Tg and the tackiness of an elastomer.

Naturally occurring materials, which are typically complex mixtures of high molecular-weight organic acids and related neutral materials, are a common form of tackifying resin. Wood or other rosins, or modified forms of such naturally occurring rosins (e.g., hydrogenated or esterified rosins) are particularly useful. Polymers of terpene, phenol- or styrene-modified terpenes, and low-molecular-weight styrene resins are also useful.

The over-tackified adhesives can be derived from an elastomer that is typically used in pressure-sensitive adhesives. Such over-tackified adhesives are low in tack or totally tack-free at room temperature (i.e., about 20° C. to about 25° C.). They derive their low tack or no tack characteristics at room temperature from their high glass transition temperatures (typically, at least about 1O° C.) and/or high shear storage moduli (typically, at least 5×10⁵ Pascals at 23° C. and 1 Hertz).

Examples of over-tackified adhesives useful in the present invention include natural rubbers, synthetic rubbers, styrene block copolymers, (meth)acrylics, poly(alpha olefins), and silicones.

Over-tackified natural rubber adhesives include natural rubber that may range in grade from a light pale crepe grade to a darker ribbed smoked sheet and includes, for example, CV-60 (a controlled viscosity rubber grade) and SNIR-5 (a ribbed smoked sheet rubber grade). Tackifying resins used to over-tackify natural rubbers generally include, but are not limited to, wood rosin and its hydrogenated derivatives, terpene resins of various softening points, and petroleum-based resins.

Over-tackified synthetic rubber adhesives include synthetic rubbers that are generally rubbery elastomers such as butyl rubber, a copolymer of isobutylene with less than 3 percent isoprene, polyisobutylene, a homopolymer of isoprene, polybutadiene, styrene-butadiene rubber, polybutadiene, or styrene-butadiene rubber, An example of a synthetic rubber is that marketed by Ameripol Synpol Corporation, Port Neches, Tex., under the trade designation “AMERIPOL 1011AE”, a styrene/butadiene rubber. Tackifiers that are useful to over-tackify synthetic rubbers include derivatives of rosins, polyterpenes, C₅ aliphatic olefin-derived resins, and C₉ aromatic/C₅ aliphatic olefin-derived resins.

Over-tackified styrene block copolymer adhesives generally include elastomers of the A-B or A-B-A type, where A represents a thermoplastic polystyrene block and B represents a rubbery block of polyisoprene, polybutadiene, or poly(ethylene-co-butylene), and resins. Examples of the various block copolymers useful in the adhesives include linear, radial, star and tapered styrene-isoprene block copolymers such as those commercially available from Shell Chemical Company, Houston, Tex., under the trade designations “KRATON D1107”, “KRATON G1657”, “KRATON G175W”, and “KRATON D1118”.

The polystyrene blocks tend to form domains in the shape of spheroids, cylinders, or lamellae that cause the block copolymer adhesives to have two-phase structures. Resins that associate with the rubber phase generally develop tack in the pressure-sensitive adhesive. Examples of rubber phase associating resins include aliphatic olefin-derived resins, such as those marketed from The Goodyear Tire & Rubber Company, Akron, Ohio under the trade designations “ESCOREZ 130W” and “WINGTACK”; rosin esters, such as those commercially available from Hercules, Inc. under the trade designations “FORAL” and “STAYBELITE Ester 1 W”, hydrogenated hydrocarbons, such as that commercially available from ExxonMobil Corporation, Houston, Tex., under the trade designation “ESCOREZ 5000”, polyterpenes, such as that marketed by Hercules, Inc., Wilmington, Del., under the trade designation “PICCOLYTE X”; and terpene phenolic resins derived from petroleum or turpentine sources, such as that commercially available under the trade designation “VICCOFYN AIOW” Resins that associate with the thermoplastic phase tend to stiffen the pressure-sensitive adhesive.

Over-tackified (meth)acrylic adhesives generally include from 100 to 80 weight percent of a C₄-C₁₂ alkyl ester component such as, for example, isooctyl acrylate, 2-ethyl-hexyl acrylate and n-butyl acrylate, and from 0 to 20 weight percent of a polar component or cohesively reinforcing component, such as, for example, acrylic acid, methacrylic acid, vinyl acetate, N-vinylpyrrolidone, and styrene macromer. The (meth)acrylic pressure-sensitive adhesives may include from 0 to 20 weight percent of acrylic acid and from 100 to 80 weight percent of isooctyl acrylate, butyl acrylate, or ethylhexyl acrylate. Useful tackifiers that can be used to over-tackify these materials are rosin esters such as that commercially available from Hercules, Inc. under the trade designation “FORAL 85,” aromatic resins such as that commercially available from Hercules, Inc. under the trade designation “VICCOTEX LC-55WE” and terpene resins such as those commercially available from Arizona Chemical Company, Jacksonville, Fla., under the trade designations “SYLVAREZ 2019” and “SYLVAREZ B-100,” Latent, over-tackified, poly(alpha-olefin) adhesives, also called poly(l-alkene) adhesives, generally include either a substantially uncrosslinked polymer or a uncrosslinked polymer that may have radiation activatable functional groups grafted thereon as described in U.S. Pat. No. 5,112,882 (Babu et al.). Tackifying materials that can be used to overtackify such adhesives are typically resins that are miscible in the poly(alpha-olefin) polymer. Useful tackifying resins include resins derived by polymerization of C₅ to C₉ unsaturated hydrocarbon monomers, polyterpenes, phenol- or styrene-modified polyterpenes, and the like. Examples of such resins based on a C₅ olefin fraction of this type include those commercially available from Goodyear under the trade designation “WINGTACK”.

Over-tackified silicone adhesives include two major components, a polymer or gum, and a tackifying resin. The polymer is typically a high molecular weight polydimethylsiloxane or polydimethyldiphenylsiloxane, that contains residual silanol functionality on the ends of the polymer chain, or a block copolymer including polydiorganosiloxane soft segments and urea terminated hard segments. The tackifying resin, which can be used to over-tackify these adhesives, include a three-dimensional silicate structure that is endcapped with trimethylsiloxy groups and also contains some residual silanol functionality. Examples of tackifying resins include those marketed by General Electric Company, Silicone Resins Division, Waterford, N.Y., under the trade designation “SR 545,” and from Shin-Etsu Silicones of America, Torrance, Calif. under the trade designation “MQD-32-2.” Typically, to over-tackify a silicone resin, the tackifier is present in an amount of at least about 50 percent by weight. Manufacture of typical silicone pressure-sensitive adhesives is described in U.S. Pat. No. 2,736,721 (Dexter). Manufacture of silicone urea block copolymer pressure-sensitive adhesive is described in U.S. Pat. No. 5,214,119 (Leir et al.).

Elastomers used in heat-activatable over-tackified adhesives can be prepared by techniques including, but not limited to, the conventional techniques of solvent polymerization, dispersion polymerization, emulsion polymerization, suspension polymerization, solventless bulk polymerization, and radiation polymerization, including processes using ultraviolet light, electron beam, and gamma radiation. These methods are well known to those skilled in the art.

In some embodiments, the heat-activatable adhesive is disposed as a layer in contact with one major surface of the cling backing, while in some embodiments the heat-activatable adhesive is disposed as two layers, one on both of the two major surfaces. The heat-activatable and/or other adhesive layer(s) may be continuous and/or may be discontinuous (e.g., having discrete regions of adhesive), and may cover some or all of the major surface(s).

The heat-activatable adhesive, depending upon its viscosity, may be coated via any of a variety of conventional coating methods such as, for example, roll coating, knife coating, hot melt coating, laminating, or extruding. The thickness of the heat-activatable adhesive layer is typically in a range of from about 1 micrometers to about 500 micrometers, although higher and lower thicknesses may also be used.

The heat-activatable adhesive layer may be applied to the cling backing by any known coating technique. Useful coating techniques include, for example, roll coating, gravure coating, knife coating, spray coating, ink jet printing, screen printing, bar coating, and curtain coating. The heat-activatable adhesive layer may be applied to the cling backing (e.g., cling vinyl or electrostatically charged film), or in the case of electrostatically charged films, the adhesive may be applied to the film prior to electrostatically charging the film.

To ensure against accidental activation of the heat-activatable adhesive (e.g., by contact with human hands or even moderately warm surfaces), the activation temperature of heat-activatable adhesive may be at least about 40, 50, 60, 70, 80 or even 90 degrees Celsius. To prevent damage to heat sensitive cling backings and/or substrates, and to allow activation using a personal hair dryer, it may be desirable in some cases that the activation temperature is less than about 100, 90, 80, 70, 60, or even 50 degrees Celsius. Other useful heat sources that may be used to activate the activatable adhesive include, for example, ovens, microwave energy, solar energy, infrared radiation, steam, hot water, heated metal (e.g., an iron), and combinations thereof.

Combinations of wax and an elastomer may also be used as the heat-activatable adhesive. Such materials function similarly to the over-tackified adhesives discussed above, except that wax is used instead of a tackifying resin to raise the rubbery plateau modulus of the elastomeric matrix.

Suitable elastomers include those mentioned for use in over-tackified adhesives herein above.

Suitable waxes include, for example, paraffin waxes and low molecular weight microcrystalline waxes (e.g., polyethylene or polypropylene waxes). Such polyolefin waxes are well known and may be obtained, for example, as micronized solids or as emulsions.

Useful paraffin waxes typically have a melting point between about 25° C. and about 180° C., for example, between about 40° C. and about 120° C. If the melting temperature is too high, the paraffin may not be compatible with the adhesive and the activation temperature of the adhesive may be too high; if too low, it may prematurely soften and cause the activatable adhesive to be aggressively tacky even at temperatures close to room temperature.

Paraffin waxes useful in heat-activatable adhesives of the invention include microcrystalline waxes (e.g., those marketed by Shell Oil Company, Houston, Tex. under the trade designation “SHELLWAX”). Paraffin waxes typically are useful in amounts of from about 1 percent or about 5 percent up to about 100 or even about 150 percent by weight based on the weight of the elastomer.

Optionally, cling articles according to the present invention may include a layer of conventional pressure-sensitive in contact with at least a portion of a major surface thereof. This auxiliary pressure-sensitive adhesive is in addition to, and not disposed on, the layer of heat-activatable adhesive. The auxiliary adhesive may, for example, comprise a layer in contact with the cling backing and any additional optional layers.

Optionally, any adhesive layer used in practice of the present invention may be provided with a surface topography such that fluid (including air) is allowed to escape as that adhesive layer is applied to a substrate. For example, the topography may be provided in the form of microchannels or grooves, which may be provided in a pattern effective to reduce or eliminate formation of air bubbles entrapped between the cling article and the substrate. Such microchannels may have any appropriate cross-sectional shape, such as round, square, triangular or trapezoidal. Typically, the microchannels or grooves may have a width of less than about 0.1 millimeters and a depth less than about 25 millimeters.

If it is desired to have a graphic image on a cling article of the present invention, then such may be printed (e.g., by electrography, screen printing, thermal mass transfer, ink jet (including ink jet techniques using water soluble inks, solvent based inks or UV curable inks), flexography, or dye sublimation) directly on the cling backing, or on an optional image-receiving layer. Image-receiving layers are typically continuous layers that may be coated onto, laminated to (e.g., by coextrusion, heat lamination, adhesive lamination), or otherwise affixed to a major surface of the cling backing opposite the heat-activatable adhesive layer. Image-receiving layers suitable for use in the present invention are well known in the graphic arts and are described, for example, in U.S. Pat. No. 5,707,722 (Iqbal et al.); U.S. Pat. No. 6,500,527 (Miller); and U.S. Published patent application 2002/0052439 (Farooq).

In addition to the optional layers mentioned above, cling articles in accordance with the present invention can include other optional layers, such as a dry erase layer. Useful optional dry erase layers are typically a smooth layer of highly crosslinked polymeric material. Details concerning materials and methods of making the optional dry erase layer may be found for example in commonly assigned U.S. application Ser. No. 10/231,568 (Bharti et al.) entitled “Method of Making Erasable Articles and Articles Therefrom”, filed Aug. 30, 2002; and in U.S. Pat. No. 5,258,225 (Katsamberis), 5,391,210 (Bilkadi et al.), and U.S. Pat. No. 5,677,050 (Bilkadi et al.), the disclosures of which are incorporated herein by reference.

Any of the layers above, whether optional or not, may include at least one optional additive. An optional additive can be selected from pigments (including fluorescent and phosphorescent pigments), dyes, fillers, ultraviolet (UV) absorbing agents, antiblocking agents, flame retardant agents, plasticizers, light stabilizers, heat stabilizers, slip agents, antistatic agents, free radical scavengers, and carrier resins for such additives, all of which are familiar to those skilled in the art.

Cling articles of the present invention may be provided in sheet of roll form. If in roll form, they may include lines of perforations enabling removal of individual sheets by tearing. If in sheet form, they may be provided, for example, individually (e.g., supported on at least one carrier sheet) or in stack form.

Cling articles of the present invention may contain perforations allowing them to be used, for example, as unidirectional privacy films and stencils.

Cling articles of the present invention have many uses including, for example, dry erase boards, memo boards, wallpaper, surface protective films (e.g., shelf-liners), privacy films, energy management films, masking, projection screens, graphic articles (e.g., automotive graphics, truck graphics, window graphics, appliques, billboards), and wall mountable easel pads.

Cling articles of the present invention may be adhered to any solid substrate. Suitable substrates may have vertical and/or horizontal surfaces, may be conductive or non-conductive, and may be painted or unpainted. Exemplary substrates include wood, masonry, architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, boxes, cabinets, doors, and ceramic tile.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all reagents used in the examples were obtained, or are available, from general chemical suppliers such as Aldrich Chemical Company, Milwaukee, Wis., or may be synthesized by known methods.

The following abbreviations are used throughout the following examples:

| ABBREVIATION | DESCRIPTION |
|---|---|
| AA | acrylic acid |
| ABP | 4-acryloyl-oxy-benzophenone was prepared |
| | generally according the procedure of Example A of |
| | U.S. Pat. No. 4,737,559 (Kellen et al.), the |
| | disclosure of which is incorporated herein by |
| | reference. |
| BHA | behenyl acrylate, obtained from Cognis Corporation, |
| | Ambler, Pennsylvania |
| EHA | 2-ethylhexyl acrylate |
| MA | methyl acrylate |
| IOA | isooctyl acrylate |
| IRG1010 | antioxidant obtained under the trade designation |
| | “IRGANOX 1010” from Ciba Specialty Chemical, |
| | Hawthorne, New York |
| F85 | glycerol ester of rosin acid available under the trade |
| | designation “FORAL 85” from Hercules, |
| | Wilmington, Delaware |
| PW1000 | hydrocarbon wax obtained under the trade |
| | designation “POLYWAX 1000” from Baker |
| | Petrolite, Sugar Land, Texas |
| WTPLUS | A synthetic hydrocarbon resin obtained under the |
| | trade designation “WINGTACK PLUS” from |
| | Goodyear Chemicals, Akron, Ohio |
| KR1107 | styrene-isoprene-styrene block copolymer obtained |
| | under the trade designation “KRATON 1107” from |
| | Kraton Polymers PLC, Houston, Texas |
| Bisamid | N,N′-bis-1,2-propyleneisophthalamide (the reaction |
| | product of 2 moles of propyleneimine and 1 mole of |
| | isophthaloyl chloride) |

The following procedures and test methods were used in the following examples:

Method of Laminating

The adhesive was coated on a siliconized polyester liner for easy transfer to the different films. The dry adhesive thickness was about 25 micrometers. The liner with adhesive was then placed onto the film with adhesive side towards film. The adhesive was rolled down by hand using a rubber-covered roller, and heating at about 46° C. using a hair dryer (obtained under the trade designation “PERFECTION CLASSIC, QUIET 1875 W” from East West Distribution Company, Deerfield, Ill.) set at low heat setting with care taken to remove air bubbles. Then the liner was heated to about to about 60° C. using the hair dryer on high heat setting, and the liner and adhesive was rolled down by hand using a rubber-covered roller for a second time resulting in a film-adhesive-liner laminate. Throughout the above procedure, the distance between the hair dryer and the liner was kept at around 15 cm.

Method of Electrostatic Charging

The liner was removed from a film-adhesive-liner laminate (8.5 inches×11 inches (22 cm×28 cm) and the resulting film-adhesive laminate was DC corona charged (with the adhesive side facing the charging bar) under ambient conditions using a horizontally arranged series of four charging bars (obtained under the trade designation “CHARGEMASTER PINNER ARC RESISTANT CHARGING BAR” from Simco Company, Hatfield, Pa.). The charging bars were spaced as follows: the center to center distance between bar 1 and bar 2 was 3.0 inches (7.6 cm), the center to center distance between bar 2 and bar 3 was 3.25 inches (8.3 cm), and the center to center distance between bar 3 and bar 4 was 3.75 inches (9.5 cm). Each charging bar was situated 1.5 inches (3.5 cm) above a corresponding grounded metal plate. A voltage of +29 kilovolts (relative to the grounded metal plates) was applied to each charging bar. Films were charged by placing them on a moving (one foot per minute (1.8 meters per minute)) continuous belt (part number: 8882802A, obtained from Light Weight Belting Corporation, Minneapolis, Minn.) that passed between the charging bars and the metal plates, such that the belt maintained contact with the metal plates. After charging, the liner was replaced on the exposed adhesive surface.

Shear Adhesion Test

A film strip measuring 2 inches by 4 inches (5.1 cm by 10.2 cm) was cut from each sample of film. The film strip was adhered to a vertically oriented surface of 40-point white paperboard (obtained under the trade designation “CRESCENT PAPERBOARD” obtained from Unisource Worldwide Company, Brooklyn Park, Minn.) that had been painted with eggshell finish latex paint (“EGGSHELL ULTRA WHITE, #110-07”, pigmented according to the “SANDY OASIS” color standard obtained from Dutch Boy, Cleveland, Ohio) and adhered using spray adhesive (obtained under the trade designation “SPRA-MENT ART & DISPLAY ADHESIVE” from 3M Company) to a 5 inches×8 inches×0.25 inch (13 cm×20 cm×0.6 cm) unpainted basswood panel. A piece of tape (¾ inch (1.9 cm) width, obtained under the trade designation “SCOTCH FILAMENT TAPE” from 3M Company) was vertically adhered to the top edge of the film strip and fastened to a cross-head of a tensile testing machine (obtained under the trade designation “SINTECH 200/S” from MTS Systems Corporation, Cary, N.C.), such that force was applied parallel to the 10.2 cm edges of the film piece. The panel and film strip assembly was vertically oriented such that the 5.1 cm edges of the film strip were positioned at the top and bottom of the film. The force necessary to cause movement of the film strip relative to the panel (i.e., shear adhesion) was determined using a cross-head speed of 2.5 cm/minute

The film strip was sequentially applied to the test panel and removed by shearing as described above.

Shear adhesion of the film strip to the test panel was measured after activating the adhesive using a heat gun (model no. HG-501A, from Master Appliance Corporation, Racine, Wis.). To keep the temperature approximately constant between film strips, the heat gun was run for 10 seconds, before uniformly heating the adhesive coated film strip for 2 seconds at a distance between the film and gun of about 7 cm. The film strip was allowed to cool to room temperature prior to performing the Shear Adhesion Test. The shear adhesion for film strips without adhesive coating was measured without going through a heat activation step.

Gel Content Determination

Gel contents reported in the following examples were determined according to this method. A known weight of the dry adhesive to be tested was placed on a pre-weighed screen basket. The polymer and screen were immersed in toluene heated to 70° C. and allowed to soak for 24 hours. After soaking, any remaining polymer on the screen was washed with more clean solvent and dried at 70° C. for 20 minutes. After drying, the sample was again weighed to obtain the weight of the polymer that remained on the screen. This procedure was repeated until a stable dry weight was obtained. The gel content in percent was calculated as the ratio of the weight of polymer remaining on the screen after soaking divided by the original weight of polymer, multiplied by 100.

Crystalline Content Test

A sample of the heat-activatable adhesive was placed in a sealed aluminum pan and a scan was run on a differential scanning calorimeter (obtained under the trade designation “DSC 7” from Perkin-Elmer, Wellesley, Mass.) using a thermal profile of from 0° C. to 100° C. at a rate of 5 degrees per minute. The heat of fusion was determined by measuring the area of the peak for the melting point of the heat-activatable adhesive during the first upwards scan of the sample. The heat of fusion was determined for a polymer consisting of pure C₂₀₊ (meth)acrylate monomer (the homopolymer) and the percent crystallinity for copolymers was determined by dividing the heat of fusion for the copolymer by the heat of fusion of the homopolymer multiplied by one hundred.

### Preparative Example P1

A heat-activatable adhesive was prepared by mixing 20 grams of 2-ethylhexyl acrylate, 19.2 grams of behenyl acrylate and 0.8 grams of acrylic acid (yielding a 50/48/2 EHA/BHA/AA terpolymer) with 60 grams of a 50/50 (weight/weight) solvent mixture of ethyl acetate/toluene, 0.12 grams of thermal initiator (obtained under the trade designation “VAZO 67” from E.I. du Pont de Nemours & Company, Wilmington, Del.) in a vessel, inerting the contents of the vessel, and heating the contents to 60° C. for 24 hours. The resulting polymeric solution was mixed with 0.04 grams of bisamid (dry weight percent based on dry weight of polymer) and coated shortly after mixing onto a 37.5 micrometers thick siliconized polyester film and dried for 15 minutes at 70° C. to give a dry adhesive coating of about 25 micrometers. The dried adhesive tapes were applied on different cling films following the Method of Laminating procedure described above. The gel content of this adhesive was measured to be about 49.5 percent, and the activation temperature was 40° C., and the crystalline content as determined according to the Crystalline Content Test was 19 percent.

### Preparative Example P2

A heat-activatable adhesive was prepared by mixing 20.8 grams of grams of EHA, 19.2 grams of BHA with 60 grams of a 50/50 (weight/weight) solvent mixture of ethyl acetate/toluene, 0.12 grams of thermal initiator (obtained under the trade designation “VAZO 67” from E.I. du Pont de Nemours & Company, Wilmington, Del.) in a vessel, inerting the contents of the vessel, and heating the contents to 60° C. for 24 hours. The resulting polymeric solutions were coated onto a 37.5 micrometers thick siliconized polyester film and dried for 15 minutes at 70° C. to give a dry adhesive coating of about 25 micrometers. The coated film was passed once (adhesive side facing the lamp) through a ultraviolet light processor obtained under the trade designation “UV PROCESSOR MODEL MC-6RQN” from Fusion Systems Corporation, Gaithersburg, Md. equipped with a H-bulb operating at full power at 10 meters per minute. The gel content of the adhesive was measured to be about 53 percent, and the activation temperature was 40° C., and the crystalline content as determined according to the Crystalline Content Test was 19 percent.

### Preparative Example P3

The heat-activatable adhesive of preparative example P3 was made by dissolving 40 grams of F85 in 40 grams methyl ethyl ketone. The solution was mixed with 220 grams of a 57.5/35/7.5 IOA/MA/AA terpolymer (intrinsic viscosity in ethyl acetate was 1.7 deciliters/gram) dissolved at 27 weight percent solids in a mixture of ethyl acetate/toluene. Just prior to coating, 0.06 grams of bisamid crosslinker was added. The mixture was agitated until homogenous and coated on a 37.5 micrometer thick siliconized polyester liner and dried at 70° C. for 15 minutes. The dry adhesive thickness was about 25 micrometers, and the gel content was 49.7 percent.

### Preparative Example P4

The heat-activatable adhesive of Preparative Example P4 was made as described for Preparative Example P3, but instead of 40 grams F85, 20 grams of F85 was used. Instead of 220 grams of the solution adhesive, 300 grams of the solution adhesive was used. This solution was coated and dried as described for Preparative Example P3. The gel content of this adhesive was measured to be 69.5 percent.

### Preparative Example P5

A heat-activatable adhesive was prepared by melt mixing 100 grams of KR1107, 40 grams of WTPLUS, 60 grams of PW1000, and 1 gram of IRG1010 in a melt mixing device (commercially available from C. W. Brabender, South Hackensack, N.J.) at about 150° C. for about 15 minutes. The resulting mixture was hot-melt extruded at 25 micrometers thickness onto BOPP film used in Example 5 (below). The activation temperature of this adhesive was 105° C.

### Examples 1-4

In these examples various adhesives as indicated in Table 1 were laminated to individual pieces of SBOPP cling film according to the Method of Laminating procedure.

The SBOPP film was a 3-layer biaxially oriented (7 by 7) film made by simultaneous 3-layer coextrusion. The two outer layers had a thickness of 0.005 mils (0.1 micrometers) and consisted of polypropylene (obtained under the trade designation “FINA-3376” from Atofina Petrochemicals, Houston, Tex.). The central layer consisted of 5 percent by weight titanium dioxide in 95 percent by weight polypropylene (FINA-3376). The total SBOPP film thickness was 1.85 mils (47 micrometers). The SBOPP films were charged according to the Method for Electrostatic Charging after carrying out the Method of Laminating procedure.

The electrostatically charged film adhesive laminates of Examples 1-4 were tested according to the Shear Adhesion Test. The results are reported in Table 1.

### Example 5

In this example the adhesive from Preparative Example P5 was hot melt extruded against a biaxially-oriented polypropylene (BOPP) cling film using a twin screw counter-rotating extruder and a hot melt drop die. The BOPP film was wrapped around a rubber coated chill roll to prevent distortion of the backing. The BOPP film of thickness 50 micrometer, type-BW9 was obtained from Nan Ya Corporation, Taipei, Taiwan. The BOPP film was charged according to the Method for Electrostatic Charging after carrying out the Method of Laminating procedure.

This electrostatically charged film adhesive laminate was tested according to the Shear Adhesion Test. The results are reported in Table 1.

### Example 6

The adhesive from Preparative Example P2 was laminated against an ionomer cling film according to the Method of Laminating procedure, and then the laminate was charged according to the Method of Electrostatic Charging.

The ionomer cling film was prepared as follows: Zinc polyethylene-methacrylic acid ionomer pellets (78 parts, obtained under the trade designation “SURLYN 1705-1” from E. I. du Pont de Nemours & Company, Wilmington, Del.), and 22 parts of a mixture of 15.4 parts titanium dioxide dispersed in 6.6 parts polyethylene (obtained under the trade designation “STANDRIDGE 11937 WHITE CONCENTRATE” from Standridge Color, Bridgewater, N.J.) were combined and extruded onto a polyester liner (2 mils (50 micrometers) thickness) using a 2.5 inch (6.4 cm) single screw extruder (model number: 2.5TMIII-30, obtained from HPM Corporation, Mount Gilead, Ohio), at a temperature of 199° C., resulting in a film having a thickness of 3 mils (80 micrometers) adhered to a polyester liner (2 mils (50 micrometers) thickness. The polyester liner was removed from the ionomer cling film prior to carrying out the Method of Lamination procedure.

This film adhesive laminate was tested according to the Shear Adhesion Test. The results are summarized in Table 1.

### Example 7

The adhesive from Preparative Example P2 was laminated against vinyl cling film following the procedure described above. Cling vinyl film was obtained under the trade designation “WINDOW COVERING FILM” with the size of 26″×36″ and 8 mil thick, item No. 107-14, was obtained from Artscape, Portland, Oreg. The cling vinyl film was then coated with the adhesive of Preparative Example P2 according to the Method of Laminating procedure above. The film adhesive laminate was tested according to the Shear Adhesion Test. The results are reported in Table 1.

TABLE 1

| | | | Shear |
|---|---|---|---|
| | | | Adhesion |
| Example | Film Type | Adhesive | (g/cm²) |
| 1 | SBOPP | P1 | 62.8 |
| 2 | SBOPP | P2 | 48.1 |
| 3 | SBOPP | P3 | >70 |
| 4 | SBOPP | P4 | >70 |
| C1 | SBOPP | None | 6.03 |
| 5 | BOPP | P5 | >70 |
| 6 | ionomer | P2 | 40.9 |
| C2 | ionomer | None | 9.27 |
| 7 | cling vinyl | P2 | 40.3 |

Various unforeseeable modifications and alterations of this invention may be made by those skilled in the art without departing from the scope and spirit of this invention, and it should be understood that this invention is not to be unduly limited to the illustrative embodiments set forth herein.

1. A cling article comprising:
a cling backing having first and second opposed major surfaces; and
a heat-activatable adhesive in contact with at least a portion of the first major surface, wherein the heat-activatable adhesive has an activation temperature of at least about 40 degrees Celsius, and wherein the heat-activatable adhesive has a gel content at or above the activation temperature of at least about 5 percent.

2. The cling article of claim 1, wherein the activation temperature is at least about 60 degrees Celsius.

3. The cling article of claim 1, wherein the activation temperature is less than about 100 Celsius.

4. The cling article of claim 1, wherein the cling backing comprises cling vinyl.

5. The cling article of claim 1, wherein the cling backing comprises an electrostatically charged film.

6. The cling article of claim 1, wherein the cling backing comprises an electret film.

7. The cling article of claim 1, wherein the heat-activatable adhesive comprises a semi-crystalline polymer.

8. The cling article of claim 1, wherein the heat-activatable adhesive comprises an over-tackified adhesive.

9. The cling article of claim 1, wherein the heat-activatable adhesive comprises wax and an elastomer.

10. The cling article of claim 1, wherein the heat-activatable adhesive has a gel content of at least 10 percent at or above the activation temperature.

11. The cling article of claim 1, wherein the heat-activatable adhesive has a gel content in a range of from about 50 to about 100 percent at or above the activation temperature.

12. The cling article of claim 1, further comprising an auxiliary adhesive in contact with at least a portion of the second major surface.

13. The cling article of claim 12, wherein the auxiliary adhesive comprises a heat-activatable adhesive.

14. The cling article of claim 12, wherein the auxiliary adhesive comprises a heat-activatable adhesive having an activation temperature of at least about 40 degrees Celsius.

15. The cling article of claim 14, wherein the auxiliary adhesive comprises a heat-activatable adhesive having an activation temperature of less than about 100 degrees Celsius.

16. The cling article of claim 1, wherein the heat-activatable adhesive forms a continuous layer.

17. The cling article of claim 1, wherein the heat-activatable adhesive forms a discontinuous layer.

18. The cling article of claim 12, wherein the auxiliary adhesive forms a continuous layer.

19. The cling article of claim 12, wherein the auxiliary adhesive forms a discontinuous layer.

20. The cling article of claim 1, wherein the article comprises a tape, a strip, a roll, or a sheet.

21. The cling article of claim 1, further comprising an image-receiving layer in contact with at least one of the first or second major surfaces.

22. The cling article of claim 1, wherein at least one of the first or second major surfaces has a graphic image thereon.

23. The cling article of claim 1, wherein the second major surface has a dry erasable layer thereon.

24. The cling article of claim 1, wherein the cling backing comprises a thermoplastic polymer selected from the group consisting of fluorinated polymers, polyolefins, copolymers of olefins and other monomers, ionomers, polyesters, polyamides, polycarbonates, polysulfones, and combinations thereof.

25. The cling article of claim 1, wherein the cling backing comprises polypropylene.

26. The cling article of claim 1, wherein the cling backing comprises a poly(ethylene-co-methacrylic acid) ionomer.

27. The cling article of claim 1, wherein the cling article is perforated.

28. The cling article of claim 1, wherein the cling backing is at least fluorescent or phosphorescent.

29. A method of adhering a cling article to a substrate comprising:
providing a cling backing having first and second opposed major surfaces and a first heat-activatable adhesive in contact with at least a portion of the first major surface, wherein the heat-activatable adhesive has an activation temperature of at least about 40 degrees Celsius, and wherein the heat-activatable adhesive has a gel content at or above the activation temperature of at least about 5 percent;
contacting the cling backing with a substrate; and
heating the heat-activatable adhesive to a temperature at which the heat-activatable adhesive becomes aggressively tacky.

30. The method of claim 29, wherein the activation temperature is at least about 60 degrees Celsius.

31. The method of claim 29, wherein the activation temperature is less than about 100 Celsius.

32. The method of claim 29, wherein the cling backing comprises cling vinyl.

33. The method of claim 29, wherein the cling backing comprises an electrostatically charged film.

34. The method of claim 29, wherein the cling backing comprises an electret film.

35. The method of claim 29, wherein the heat-activatable adhesive comprises a semi-crystalline polymer.

36. The method of claim 29, wherein the heat-activatable adhesive comprises an over-tackified adhesive.

37. The method of claim 29, wherein the heat-activatable adhesive comprises wax and an elastomer.

38. The method of claim 29, wherein the heat-activatable adhesive has a gel content of at least 10 percent at or above the activation temperature.

39. The method of claim 29, wherein the heat-activatable adhesive has a gel content in a range of from about 50 to about 100 percent at or above the activation temperature.

40. The method of claim 29, wherein the heat-activatable adhesive forms a continuous layer.

41. The method of claim 29, wherein the heat-activatable adhesive forms a discontinuous layer.

42. The method of claim 29, wherein the cling backing comprises a tape, a strip, a roll, or a sheet.

43. The method of claim 29, wherein at least one of the first or second major surfaces contacts an image-receiving layer.

44. The method of claim 29, wherein at least one of the first or second major surfaces has a graphic image thereon.

45. The method of claim 29, wherein the second major surface has a dry erasable layer thereon.

46. The method of claim 29, wherein the cling backing comprises a thermoplastic polymer selected from the group consisting of fluorinated polymers, polyolefins, copolymers of olefins and other monomers, ionomers, polyesters, polyamides, polycarbonates, polysulfones, and combinations thereof.

47. The method of claim 29, wherein the cling backing comprises polypropylene.

48. The method of claim 29, wherein the cling backing comprises a poly(ethylene-co-methacrylic acid) ionomer.

49. The method of claim 29, wherein the cling article is perforated.

50. The method of claim 29, wherein the cling backing is at least fluorescent or phosphorescent.

51. The method of claim 29, wherein the substrate comprises a liner.

52. The method of claim 29, wherein the substrate is selected from the group consisting of a window, an architectural surface, or an automobile.

53. An assembly comprising:
a cling backing having first and second opposed major surfaces;
a first heat-activatable adhesive in contact with at least a portion of the first major surface, wherein the heat-activatable adhesive has a first activation temperature of at least about 40 degrees Celsius, and wherein the heat-activatable adhesive has a gel content at or above the activation temperature of at least about 5 percent; and
a substrate in contact with the heat-activatable crosslinked adhesive.

54. The assembly of claim 53, wherein the first activation temperature is at least about 60 degrees Celsius.

55. The assembly of claim 53, wherein the first activation temperature is less than about 100 Celsius.

56. The assembly of claim 53, wherein the cling backing comprises cling vinyl.

57. The assembly of claim 53, wherein the cling backing comprises an electrostatically charged film.

58. The assembly of claim 53, wherein the cling backing comprises an electret film.

59. The assembly of claim 53, wherein at least one of the first or second major surfaces contacts an image-receiving layer.

60. The assembly of claim 53, wherein at least one of the first or second major surfaces has a graphic image thereon.

61. The assembly of claim 53, wherein the second major surface has a dry erasable layer thereon.

62. The assembly of claim 53, wherein the cling backing comprises a thermoplastic polymer selected from the group consisting of fluorinated polymers, polyolefins, copolymers of olefins and other monomers, ionomers, polyesters, polyamides, polycarbonates, polysulfones, and combinations thereof.

63. The assembly of claim 53, wherein the cling backing comprises polypropylene.

64. The method of claim 53, wherein the substrate comprises a liner.
